(19) United States
(12) Patent Application Publication
(10) Pub. No.: US 2015/0082782 A1
(43) Pub. Date: Mar. 26, 2015

(54) INDEPENDENT FLOW RATE CONTROLLING HYDRAULIC SYSTEM FOR PRESSURE CONTROL OF EXCAVATOR AND INDEPENDENT HYDRAULIC PRESSURE CONTROLLING METHOD USING THE SAME

(71) Applicant: HYUNDAI HEAVY INDUSTRIES CO., LTD., Ulsan (KR)

(72) Inventors: Lim-Gook CHOI, Busan (KR); Dong-Bin SHIN, Ulsan (KR); Tae-Sung PARK, Ulsan (KR); Jong-Chan LEE, Seongnam-si (KR)

(73) Assignee: HYUNDAI HEAVY INDUSTRIES CO., LTD., Ulsan (KR)

(21) Appl. No.: 14/555,973

(22) Filed: Nov. 28, 2014

Related U.S. Application Data
(63) Continuation-in-part of application No. PCT/KR2013/004585, filed on May 27, 2013.

(30) Foreign Application Priority Data
May 29, 2012 (KR) 10-2012-0056687

(51) Int. Cl. F15B 11/16; E02F 9/22

(52) U.S. Cl. CPC F15B 11/162; E02F 9/2278; F15B 2211/3144; F15B 2211/413; F15B 2211/513
USPC 60/327; 60/422

(57) ABSTRACT

An independent flow rate controlling hydraulic system for pressure control of an excavator, in which a hydraulic system of the excavator can be variably controlled via independent flow rate control. The hydraulic system includes a plurality of actuators which actuate a working apparatus, a pressure control-type hydraulic pump which feeds working fluid to the actuator, first and second electronic proportional control valves which are disposed at a piston-side inlet flow path and a load-side inlet flow path connected from the hydraulic pump to the actuators, third and fourth electronic proportional control valves which are disposed at a piston-side outlet flow path and a load-side outlet flow path connected from the actuators to a hydraulic tank, and a control unit which variably controls areas of the flow paths by controlling the first, second, third and fourth electronic proportional control valves depending on an amount by which a control stick is manipulated.

### CROSS-REFERENCE TO RELATED APPLICATIONS

This is a Continuation-in-part Application of PCT/KR2013/004585, filed on May 27, 2013, which designates the United States and claims the benefit of priority from Korean Patent Application No. 10-2012-0056687, filed on May 29, 2012, the disclosures of both of which are expressly incorporated by reference herein in their entireties.

### TECHNICAL FIELD

The present invention relates to an independent flow rate controlling hydraulic system for pressure control of an excavator and an independent hydraulic pressure controlling system using the same, and more particularly, to an independent flow rate controlling hydraulic system for pressure control of an excavator in which the areas of flow paths are variably controlled using electronic proportional control valves which are disposed on each flow path that is necessary for the control over an actuator, whereby the degree of freedom of the flow control is significantly increased, and an independent hydraulic pressure controlling system using the same.

BACKGROUND ART

Hydraulic systems for an excavator of the related art can be generally divided into an open-center system and a closed-center system depending on the presence of a bypass flow path through which a predetermined flow rate that is discharged from a pump when a remote control valve (RCV) is in neutral. The open-center system has a bypass flow path, whereas the closed-center system does not have a bypass flow path. The open-center system is also divided into a negative flow control system and a positive flow control system, whereas the closed center system is represented by a load sensing system. The respective systems have the following characteristics.

1) Negative Flow Control System

FIG. 1 shows a negative flow control system of the related art. The negative flow control system is designed to control a flow rate discharged from a pump based on variations in pressure PN in the bypass flow path depending on changes in the flow rate of the bypass flow path.

The values of the areas of variable orifices A1, A2 and A3 shown in FIG. 1 are determined by notches formed in one spool, and the relative ratios of the values are changed by being correlated to each other by the displacement of the spool. Among them, the pressure PN in the bypass flow path is changed as the flow rate that passes along a bypass flow path 80 is changed depending on a load pressure PL that varies depending on the area of the orifice A2 and a load, and the changing PN is transferred to the pump via the flow path. In this fashion, this system controls the flow rate discharged from the pump.

2) Positive Flow Control System

FIG. 2 shows a positive flow control system of the related art. The positive flow control system is designed to control a flow rate discharged from pump based on a secondary pressure P2 of a remote control valve (RCV). The secondary pressure P2 of the RCV is changed as an operator manipulates the RCV, and in response to a variation in the spool that is determined thereby, the areas of variable orifices A1, A2 and A3 are varied depending on correlated ratios which are determined when notches are formed. However, unlike the negative flow control system, the flow rate discharged from the pump is controlled by the secondary pressure p2 of the RCV, and the pressure PN in a bypass flow path 80 is not transferred to the pump. Accordingly, this system does not participate in the control over the flow rate of the pump.

3) Load Sensing System

FIG. 3 shows a load sensing system of the related art. The load sensing system is designed to control a flow rate discharged from a pump depending on the areas of variable orifices A1 and A2 and a pressure difference dP1 (PL1-PA1) between upstream and downstream ends of the orifices. An RCV secondary pressure P2 is changed in response to RCV manipulation by a driver, and in response to a variation in the spool that is determined thereby, the areas of variable orifices A1 and A2 are varied depending on correlated ratios which are determined when notches are formed. Here, the pressure difference between the upstream and downstream ends of the variable orifice A1 are maintained at a preset constant value, and the flow rate of the pump at this time is determined by a pump pressure PP and a load pressure PL that can generate a pressure PA1 past a pressure compensation valve. When a plurality of actuators having different load pressures is concurrently operating, the flow rate of the pump is determined by selecting a larger load pressure from among the different load pressures via a check valve.

In the existing systems as described above, it is typical that one spool manages one actuator, and the areas and flow rates of several flow paths connected to the actuator that is managed by the corresponding spool are concurrently controlled via several notches formed in the spool via machining. Therefore, in some aspects, they fail to efficiently correspond to changes in the environment in which they are used, such as a load size, a direction, a possibility of the use of gravitational energy, or the like. Depending on the behaviors and preferences of individual operators in operating excavators, an excavator's operability in response to changes is limited, thereby causing inconvenience for the operator. In addition, the degree of freedom of the system for hydraulic control is limited, thereby making it difficult to improve energy efficiency.

The information disclosed in the Background of the Invention section is only for the enhancement of understanding of the background of the invention, and should not be taken as an acknowledgment or any form of suggestion that this information forms a prior art that would already be known to a person skilled in the art.

### RELATED ART DOCUMENT

Patent Document 1: Korean Laid-Open Patent Publication No. 10-2009-0059180 (2009. 06. 11)

Patent Document 2: Korean Patent No. 10-0651695 (2006. 11. 23)

### DISCLOSURE

### Technical Problem

Accordingly, the present invention has been made keeping in mind the above problems occurring in the related art, and is intended to provide an independent flow rate controlling hydraulic system for pressure control of an excavator in which electronic proportional control valves are disposed on each flow path connected to an actuator, wherein a hydraulic system of the excavator can be variably controlled via independent flow rate control, and an independent hydraulic pressure controlling system using the same.

The present invention is also intended to provide an independent flow rate controlling hydraulic system for pressure control of an excavator in which a pressure control-type pump is disposed in a hydraulic system of the excavator, and by which the hydraulic system of the excavator can be implemented as a closed-center system, and an independent hydraulic pressure controlling system using the same.

### TECHNICAL SOLUTION

In order to achieve the above object, according to one aspect of the present invention, there is provided an independent flow rate controlling hydraulic system for pressure control of an excavator. The hydraulic system includes a plurality of actuators which actuate a working apparatus; a pressure control-type hydraulic pump which feeds working fluid to the actuator; first and second electronic proportional control valves which are disposed at a piston-side inlet flow path and a load-side inlet flow path connected from the hydraulic pump to the actuators; third and fourth electronic proportional control valves which are disposed at a piston-side outlet flow path and a load-side outlet flow path connected from the actuators to a hydraulic tank; and a control unit which variably controls areas of the flow paths by controlling the first, second, third and fourth electronic proportional control valves depending on an amount by which a control stick is manipulated.

According to the present invention, since the electronic proportional control valves are disposed on each flow path that is required for the control over a plurality of actuators which actuate a working apparatus, there are effects in that each electronic proportional control valve can be independently controlled depending on an amount by which the control stick is manipulated, thereby controlling the flow path and the flow rate (independent flow rate control). It is therefore possible to significantly increase the degree of freedom in flow rate control over heavy construction equipment such as an excavator.

According to the present invention, the effects of minimizing the inconvenience of an operator and improving fuel efficiency can be expected by the improved degree of freedom in flow rate control over heavy construction equipment.

According to the present invention, the electronic proportional control valves are disposed on the inlet-side flow path and the outlet-side flow path of the actuators which actuate the working apparatus such that they cooperate with the control unit. It is therefore possible to efficiently obtain operability (the speed of the working apparatus) intended by the operator. In the case of complex operation of the working apparatus, it is unnecessary to provide a separate valve device which controls the variable speed of the actuator.

According to the present invention, the pressure control-type hydraulic pump controls the pressure under the control of the control unit in response to the amount by which the control stick is manipulated. The flow paths and the flow rates that flow into each actuator are controlled by the electronic proportional control valves. Consequently, this has the effect of realizing a closed-center system in which a predetermined flow rate is not discharged from the pump when the control stick is in neutral and there are no bypass flow paths.

### DESCRIPTION OF DRAWINGS

FIG. 1 is an example view showing a negative flow control system of the related art;

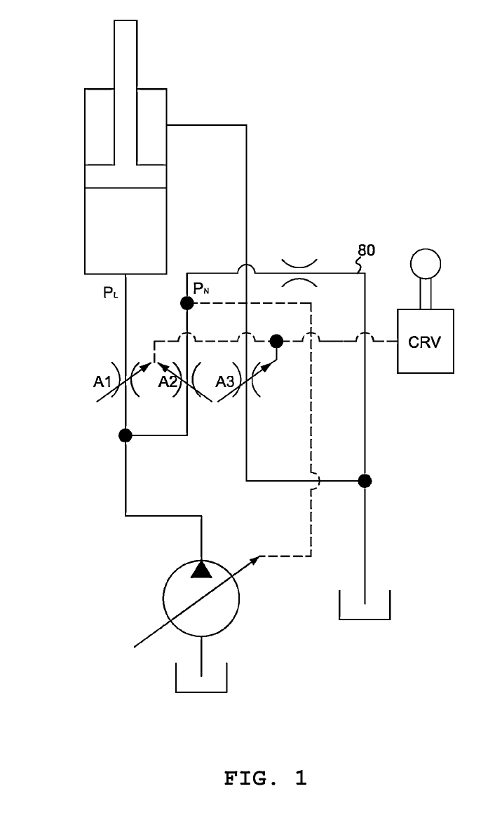

FIG. 2 is an example view showing a positive flow control system of the related art;

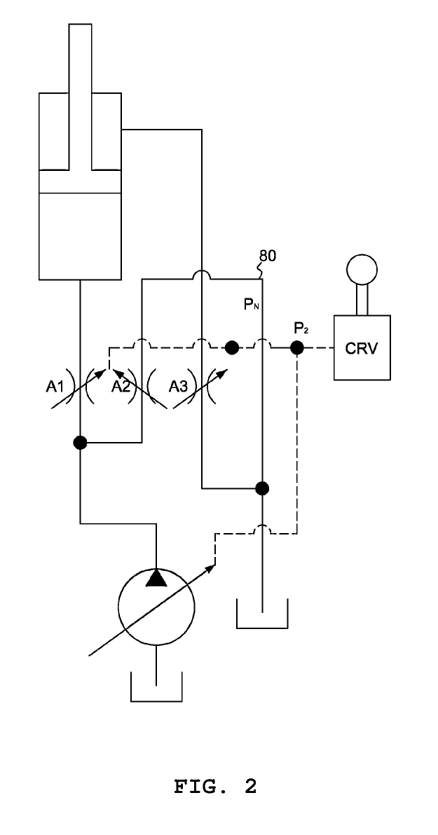

FIG. 3 is an example view showing a load sensing system of the related art;

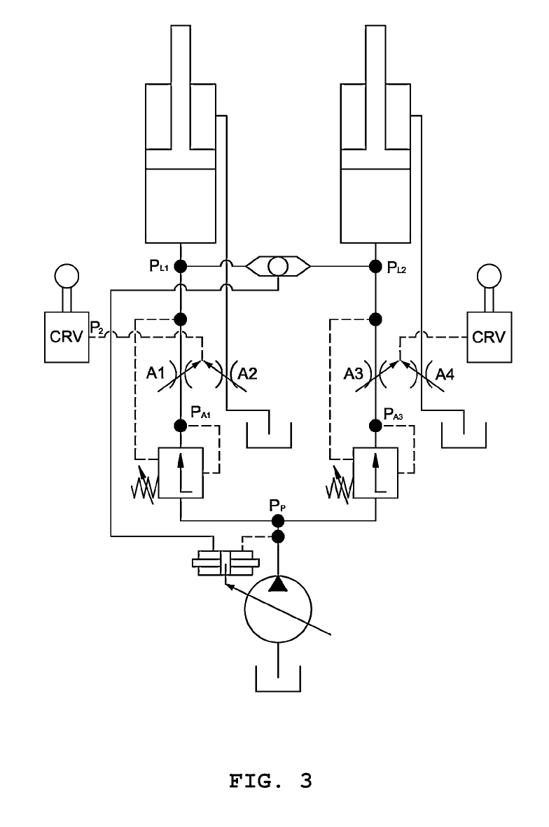

FIG. 4 is an example view showing the configuration of the present invention;

FIG. 5 is an example view showing an algorithm of the basic operation of the hydraulic pump according to the present invention;

and

FIG. 6 is an example view showing an algorithm of the basic operation of the valve according to the present invention.

(Description of Reference Numerals)

| | |
|---|---|
| 10: actuator | 20: hydraulic pump |
| 31: piston-side inlet flow path | |
| 32: load-side inlet flow path | |
| 33: piston-side outlet flow path | |
| 34: load-side outlet flow path | |
| 41: first electronic proportional control valve | |
| 42: second electronic proportional control valve | |
| 43: third electronic proportional control valve | |
| 44: fourth electronic proportional control valve | |
| 50: hydraulic tank | 60: control stick |
| 70: control unit | |

### MODE FOR INVENTION

An independent flow rate controlling hydraulic system (an independent metering system) for pressure control of an excavator variably controls the areas of flow paths with electronic proportional control valves respectively disposed along all flow paths in order to significantly increase the degree of freedom in flow rate control. As major characteristics, the independent flow rate controlling hydraulic system has a pressure control-type hydraulic pump disposed therein, and is embodied as a closed-center system.

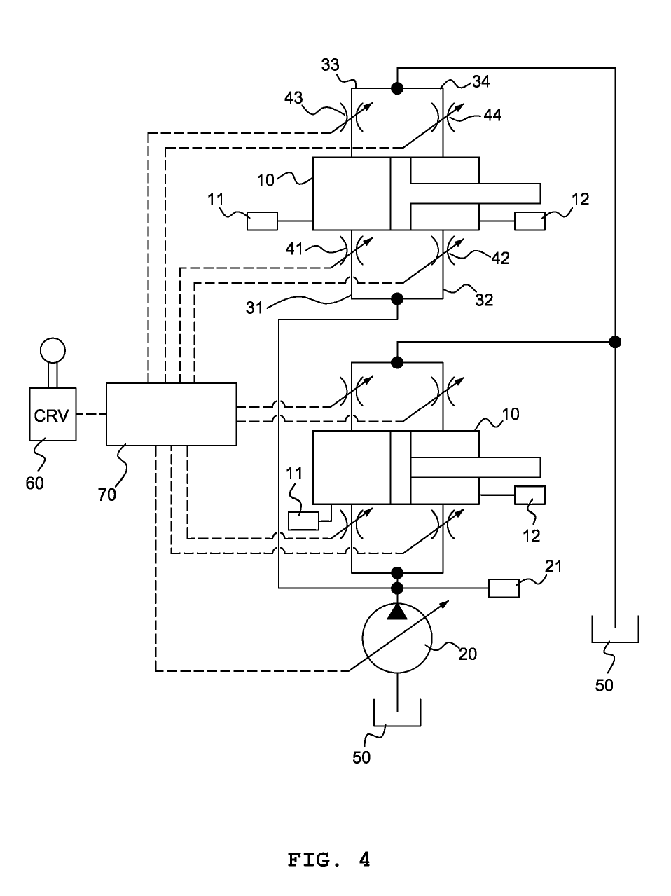

FIG. 4 is an example view showing the configuration of the present invention. The present invention includes a plurality of actuators 10 which actuate a working apparatus, a pressure control-type hydraulic pump 20 which feeds working fluid to the actuators 10, first and second electronic proportional control valves 41 and 42 which are disposed at a piston-side inlet flow path 31 and a load-side inlet flow path 32 connected from the hydraulic pump 20 to the actuators 10, third and fourth electronic proportional control valves 43 and 44 which are disposed at a piston-side outlet flow path 33 and a load-side outlet flow path 34 connected from the actuators 10 to a hydraulic tank 50, and a control unit 70 which variably controls the areas of flow paths by controlling the first, second, third and fourth electronic proportional control valves 41, 42, 43 and 44 depending on an amount by which a control stick 60 is manipulated.

The hydraulic pump 20 is a pressure control-type hydraulic pump which is actuated by an engine and feeds working fluid to a plurality of actuators. Here, a flow rate discharged from the hydraulic pump 20 is controlled by a control unit 70.

The actuator 10 is intended to actuate a variety of working apparatuses (not shown), and is connected to the hydraulic pump 20 via the piston-side inlet flow path 31 and to the hydraulic tank 50 via the load-side inlet flow path 32. The actuators 10 are provided in multiple numbers.

The first electronic proportional control valve 41 is disposed on the piston-side inlet flow path 31, the second electronic proportional control valve 42 is disposed on the load-side inlet flow path 32, the third electronic proportional control valve 43 is disposed on the piston-side outlet flow path 33, and the fourth electronic proportional control valve 44 is disposed on the load-side outlet flow path 34.

Each of the first, second, third and fourth electronic proportional control valves 41, 42, 43 and 44 is disposed on a corresponding flow path which is connected to each actuator 10, and is connected to the control unit 70 so as to be controlled depending on the amount by which the control stick 60 is manipulated.

The control unit 70 is connected to the control stick 60, and receives information on the amount by which the control stick 60 is manipulated. The control unit 70 controls the speed of the actuators 10 by controlling the first, second, third and fourth electronic proportional control valves 41, 42, 43 and 44 connected to the actuators 10 and the pressure control-type hydraulic pump 20 following an algorithm that has been previously input, based on the input information on the amount by which the control stick 60 is manipulated.

The present invention having the above-mentioned configuration realizes a closed-center system which conducts independent flow rate control in which each actuator 10 is controlled by the electronic proportional control valves 41, 42, 43 and 44. A predetermined flow rate is not discharged from the pump when the control stick is in neutral, and there are no bypath flow paths.

In the present invention having the above-mentioned configuration, when the operator manipulates the control stick RCV, the number of the actuators which concurrently operate and the information on the amount by which the control stick 60 is manipulated are input, and the speed of each actuator is determined following the algorithm that has been previously input. In addition, the first, second, third and fourth electronic proportional control valves and the pressure control-type pump are controlled by the control unit, and the areas of the variable orifices that manage the motion of the actuators and the pressure difference between the upstream and downstream ends of the variable orifices are controlled. Accordingly, a target speed of the actuator according to an intention of the operator is realized.

Reference will be made in detail hereinafter to algorithms of the basic operations of the hydraulic pump and the valve according to the invention in conjunction with the accompanying drawings.

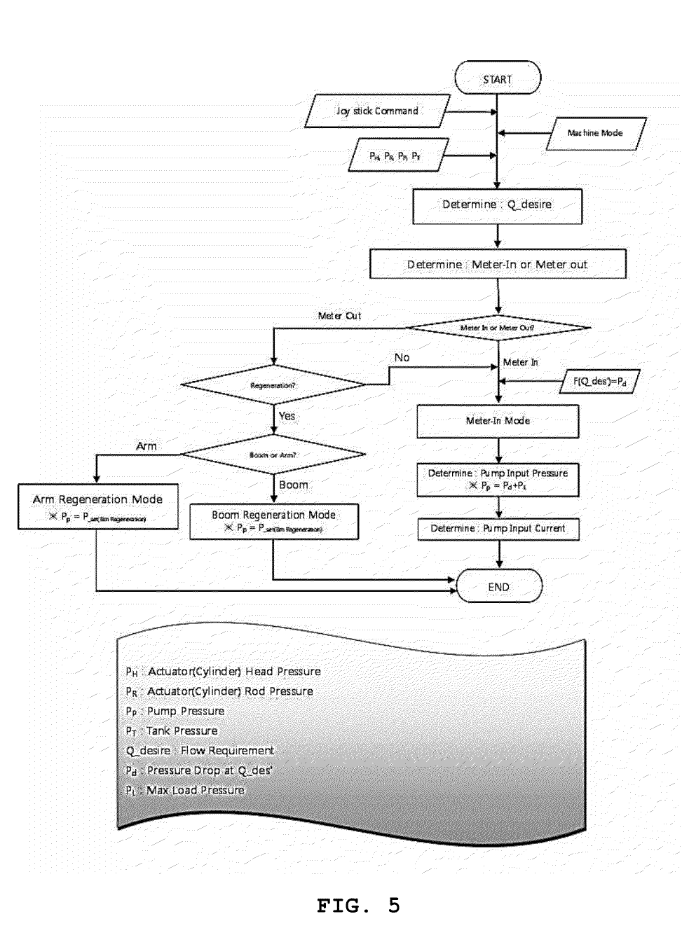

FIG. 4 is an example view showing the configuration of the present invention, FIG. 5 is an example view showing an algorithm of the basic operation of the hydraulic pump according to the present invention.

When the amount by which the control stick 60 is manipulated is detected, the type of a working apparatus required to work is determined from among the plurality of actuators 10, such as a boom, an arm and a bucket, and the flow rate required is also determined. At the same time, the pressures of all working apparatuses are input to the control unit 70 via pressure sensors 11 and 12 connected to the piston side and the load side of the plurality of actuators 10.

Here, the unit state previously set by the operator is also input as a control signal. Through previously-input calculations based on the previously-input pressures of the working apparatuses and the type of the working apparatus required, the mode of controlling the working apparatus required is determined to ascertain whether it is a meter-in operation (flow rate control in which the flow enters the actuator) or a meter-out operation (flow rate control in which the flow returns from the actuator to the tank).

When the operation is determined to be the meter-in operation, the pressure of the hydraulic pump 20 is controlled by adding a loss value in the pressure of the system according to the required flow rate to a maximum value of the previously-input pressure of each working apparatus. At this time, the hydraulic pump 20 is controlled by converting the set pressure to a current value or a pressure value according to the characteristics of the pump.

When the operation is determined to be the meter-out operation, regeneration mode is set by determining whether or not the regeneration of the flow rate is possible based on a control stick input value that was previously-input. In the case of a working apparatus in which regeneration is impossible, the control mode is converted to the meter-in operation, and subsequently the operation is controlled in the same mode as in the former meter-in operation.

When regeneration is necessary, the control is carried out separately over the boom and the arm, which are two typical working apparatuses. Since the two working apparatuses have different ways of regenerating the flow rate, the pump is controlled according to different modes, i.e. boom regeneration mode and arm regeneration mode, based on different pieces of information.

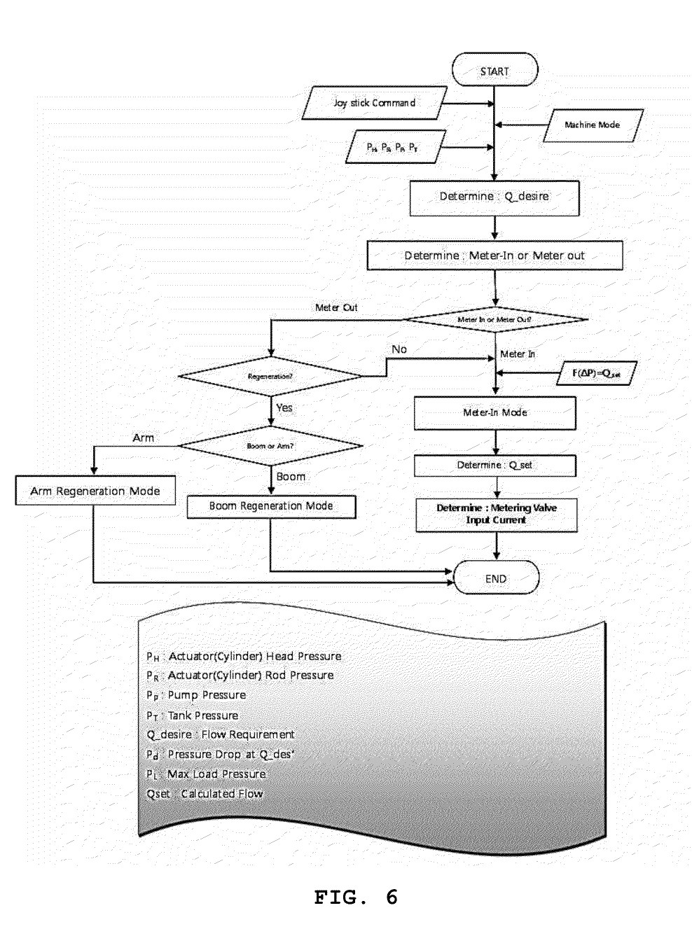

In addition, a sensor 21 able to measure the pressure of the pump is added. The addition of the sensor 21 can lead to the constitution of a pressure compensation algorithm, thereby more reliably controlling the pressure of the pump. FIG. 6 is an example view showing an algorithm of the basic operation of the valve according to the present invention. The algorithm of the basic operation of the valve during the operation of the working apparatus is similar to the algorithm of determining the pump mode. Specifically, when the amount by which the lever of the control stick 60 is manipulated is detected, pressures are input via the pressure sensors 11 and 12 disposed at the plurality of actuators 10, and subsequently conversion to a corresponding mode from among arm regeneration mode, boom regeneration mode and meter-in mode is carried out.

When it is converted to the arm regeneration mode, the hydraulic pump 20 adjusts the areas of opening of the first electronic proportional control valve 41 disposed at the piston-side inlet flow path 31, the third electronic proportional control valve 43 disposed at the piston-side outlet flow path 33 and the fourth electronic proportional control valve 44 disposed at the load-side outlet flow path 34, whereby the amount of regeneration and an arm-in (arm-retraction) speed are controlled.

When it is determined to be the boom regeneration mode, the second electronic proportional control valve 42 disposed at the load-side inlet flow path 32 remains closed, and the areas of opening of the third and fourth electronic proportional control valves 43 and 44 disposed at the piston-side and load-side outlet flow paths 33 and 34 are adjusted, whereby the amount of regeneration and a boom-down speed (boom lowering speed) are controlled.

When it is determined to be the meter-in mode, due to a pump pressure Pₚ=P_{d}+P_{L} determined by the hydraulic pump 20, an amount of pressure drop ΔP at the upstream and downstream ends of the first and second electronic proportional control valves 41 and 42 disposed at the piston-side and load-side inlet flow paths 31 and 32 are maintained constant by the hydraulic pump 20. In the circumstance of a predetermined pressure difference, information on the flow rate control characteristics of the valves is input, and the area of opening within which a required flow rate can occur is determined. A current for forming the area of opening calculated by the control unit 70 is applied to the valves.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. An independent flow rate controlling hydraulic system for pressure control of an excavator, the hydraulic system comprising:
a plurality of actuators (10) which actuate a working apparatus;
a pressure control-type hydraulic pump (20) which feeds working fluid to the actuators (10);
first and second electronic proportional control valves (41, 42) which are disposed at a piston-side inlet flow path (31) and a load-side inlet flow path (32) connected from the hydraulic pump (20) to the actuators (10);
third and fourth electronic proportional control valves (43, 44) which are disposed at a piston-side outlet flow path (33) and a load-side outlet flow path (34) connected from the actuators (10) to a hydraulic tank (50); and
a control unit (70) which variably controls areas of the flow paths by controlling the first, second, third and fourth electronic proportional control valves (41, 42, 43, 44) connected to the actuators (10) depending on an amount by which a control stick (60) is manipulated,
wherein the areas of the flow paths are variably controlled by the first, second, third and fourth electronic proportional control valves depending on the amount by which the control stick is manipulated.

2. An independent flow rate controlling method using the independent flow rate controlling hydraulic system for pressure control of an excavator as claimed in claim 1, the method comprising:
in response to an amount by which a lever of the control stick is manipulated being detected, converting to a corresponding mode selected from among: arm regeneration mode, boom regeneration mode, and meter-in mode based on a pressure input from pressure sensors disposed on the plurality of actuators;
when converted to the arm regeneration mode, adjusting, at the hydraulic pump, areas of opening of the first electronic proportional control valve disposed at the piston-side inlet flow path, the third electronic proportional control valve disposed at the piston-side outlet flow path and the fourth electronic proportional control valve disposed at the load-side outlet flow path, thereby controlling an amount of regeneration and an arm-retraction speed;
when determined to be the boom regeneration mode, maintaining the second electronic proportional control valve disposed at the load-side inlet flow path in a closed state, and adjusting the areas of opening of the third and fourth electronic proportional control valves disposed at the piston-side and load-side outlet flow paths, thereby controlling the amount of regeneration and a boom lowering speed; and
when determined to be the meter-in mode, maintaining, at the hydraulic pump, an amount of pressure drop (ΔP) at upstream and downstream ends of the first and second electronic proportional control valves disposed at the piston-side and load-side inlet flow paths to be constant due to a pump pressure (Pₚ=P_{d}+P_{L}) determined by the hydraulic pump, and in response to information on flow rate control characteristics of the valves being input in a circumstance of a predetermined pressure difference, determining an area of opening in which a required flow rate is to be formed.

3. The independent flow rate controlling method according to claim 2, wherein the pump further comprises a sensor able to measure the pump pressure, whereby a pressure compensation algorithm is to be formed.
